(19) United States
(12) Patent Application Publication
(10) Pub. No.: US 2013/0037384 A1
(43) Pub. Date: Feb. 14, 2013

(54) INCREMENTAL MULTI-POSITION DETECTION SYSTEM FOR A REVOLVING ELECTROMAGNETIC TRANSFER SYSTEM

(71) Applicant: Martin Reinisch, Esslingen (DE)

(72) Inventor: Martin Reinisch, Esslingen (DE)

(73) Assignee: ROBERT BOSCH GMBH, Stuttgart (DE)

(21) Appl. No.: 13/643,387

(22) PCT Filed: Apr. 18, 2011
(86) PCT No.: PCT/EP2011/056137

§ 371 Date: Oct. 25, 2012

(30) Foreign Application Priority Data
Apr. 28, 2010 (DE) 102010028333.9

(51) Int. Cl. B65G 43/08

(52) U.S. Cl. 198/464.2

(57) ABSTRACT

A transport apparatus (2) for conveying a product is disclosed. The transport apparatus (2) comprises a movable conveying element (8) which is intended to convey the product and has a pattern (52) which extends over a predetermined pattern length (66) in the direction of movement (16) of the conveying element (8) and has a multiplicity of travel increments (56, 58); a stationary, peripherally arranged running rail (6) which defines a running path (14) for the conveying element (8) and has a multiplicity of position sensors (20) on the running path (14), the distances (18) between which are shorter than the pattern length (66); and a measuring device (12) which is designed to determine an instantaneous position of the conveying element (8) on the running path (14), wherein, when the pattern enters and/or exits the measuring region (48) of a position sensor (20), the measuring device (12) determines the instantaneous position with respect to a reference position of the conveying element (8) on the running path (14), said reference position being derived from the position of the corresponding position sensor (20), monitors at least one of the position sensors (20), in the measuring region (48) of which the conveying element (8) is located, and increments or decrements the instantaneous position if a travel increment (56, 58) passes a position sensor (20) being monitored.

### BACKGROUND OF THE INVENTION

Transportation apparatuses for conveying products for filling packaging machines, for example for chocolate bars, bags, bottles etc., generally comprise moveable conveying elements, called carriers, which are provided for conveying the product, and a stationary, revolving running rail which defines a running path for the carriers.

Incremental travel measurement systems are used for the parallel, that is to say simultaneous, determination of the carrier positions of the individual carriers in transportation apparatuses of this kind. To this end, a grid, also called an incremental track, is generally provided on the side of the transportation apparatus which is fixed to the frame, and an incremental sensor is provided on the carrier, this incremental sensor allowing the passed travel increments of the grid to be counted during the run and thus allowing the position of the carrier in the transportation apparatus to be determined.

The incremental travel measurement system is usually constructed from commercially available magnetic strip sensors. In this case, the grid is a magnetic strip with alternating polarity which generally comprises a large number of magnets which are each lined up with one another with opposing polarity. In this case, the incremental sensor on the carrier is a magnetic field sensor, for example a Hall sensor or a magnetoresistive sensor, called MR sensor. However, this requires that both the power supply for the sensor and the data transmission to the moving carrier have to be ensured.

Furthermore, additional sensors for evaluating a reference mark are required in order to reset the meters for determining the carrier position in the transportation apparatus. The number of these reference marks depends on how long a reference run in the transportation apparatus has to be at a maximum.

DE 43 35 004 C2 discloses a travel sensor based on a resistive potentiometer with a linear or circular measurement standard. The travel distance can be ascertained by means of evaluation electronics on the basis of the change in resistance as part of the voltage division caused by the carrier. In this way, only one position per sensor can be detected in respect of the detection of the absolute carrier positions. Magnetostrictive position sensors can be used for the parallel measurement of more than one carrier position per sensor. However, the possible measurement length and the number of carriers are very limited. In addition, the running times are so long that no dynamic movements, for example with a linear motor, can be realized with a travel measurement system of this kind.

### SUMMARY OF THE INVENTION

In contrast to the above, the transportation apparatus according to the invention has the advantages that an incremental travel measurement system can be integrated in an existing guidance system for the conveying element, and can be produced without wear and in a cost-effective manner. According to the invention, this is achieved in that a moveable conveying element which is provided for conveying the product is provided with a grid which extends over a predetermined grid length in the movement direction of the conveying element and has a large number of travel increments. Travel increments of the grid which are situated next to one another can be clearly distinguished from one another by measurement. If the travel increments are selected such that they can be distinguished from one another by measurement without an external energy supply, the conveying element can be of fully passive design entirely without active components, and therefore neither a supply of electrical energy to the conveying element nor a transmission of measurement signals to or from the conveying element is necessary. As a result, the conveying element can not only be produced in a more cost-effective manner, but it is also more fail-safe. A large number of position sensors is arranged along a running path which defines a running distance for the conveying element, the distances between said large number of position sensors being smaller than the grid length. As a result, the incremental travel measurement system can be freely projected, and therefore a minimum number of position sensors can be provided for a given length of the conveying element and the entire system is not unnecessarily expensive. A measurement device is designed to determine a current position of the conveying element on the running path, with the measurement device, when the grid enters and/or exits the measurement region of a position sensor, defining the current position with respect to a reference position, which is derived from the position of the corresponding position sensor, of the conveying element on the running path, monitoring at least one of the position sensors, the conveying element being located in the measurement region of said at least one position sensor, and incrementing or decrementing the current position when a travel increment passes a monitored position sensor. This allows the incremental travel measurement system to be referenced and incremented by means of a single sensor and allows highly dynamic travel measurements, with the reference run making up only a fraction of the total travel distance. Therefore, dedicated sensors for referencing the incremental travel measurement system are superfluous.

The position sensors can be arranged in a running rail which runs along the running path, and therefore the running rail additionally forms a housing for the position sensors and the transportation apparatus can be of more compact design. As a result, it is possible to dispense with a separate apparatus for accommodating the position sensors.

The grid can have travel increments which can be distinguished from one another in an optical, electrical or magnetic manner, it being possible for the position sensors to be provided in accordance with the optical, electrical or magnetic evaluation of the grid. In a particular embodiment, the grid can be a magnetic strip with travel increments which are lined up next to one another with alternating polarity, and the position sensors can be magnetic field sensors. This magnetic strip can be used not only as a grid for the incremental travel measurement but also as a rotor for driving the conveying element when a corresponding drive field is provided on the stator side of the stationary running rail. The magnetic strip can be arranged on the lower face and/or on the sides of the conveying element.

In a particular development of the invention, the travel increments which are lined up next to one another with alternating polarity can diverge from one another in the form of a fan as seen from one side of the grid. This is particularly advantageous when the conveying element is intended to move on a purely circular running rail without straight sections since the fan-like design of the travel increments is thus optimally matched to the curved shape of the running rail.

In a particular embodiment, the grid length can correspond to the length of the conveying element in the movement direction of the conveying element, and therefore detection of the conveying element by measurement is possible immediately as said conveying element enters the measurement region of the respective position sensor.

In a further particular design of the invention, the running rail can be composed of at least two running rail segments, and therefore they form, together with the position sensors, autonomous modular sensor modules for linear regions, that is to say straight running rail segments, and for non-linear regions, that is to say, for example, running rail segments with 90° or 180° curves, and the transportation system can be extended in a modular manner to individual running rail shapes.

In a preferred embodiment, the measurement device can comprise an evaluation circuit which, in a transition region of the conveying element between two position sensors, is suitable for switching on the monitoring of a position sensor when the grid enters its measurement region, and switching off said monitoring when the grid exits its measurement region. This ensures that ultimately only a single position sensor detects the position of the conveying element, even if the conveying element is located in the measurement region of a plurality of position sensors.

In a particular development, the measurement device can be designed to weight the position sensors in the transition region. This prevents jumps in the measurement signal, and therefore the conveying element can be smoothly transferred from one position sensor to the next position sensor with a fluid transition.

In a further preferred development, the measurement device can have a switching device which is suitable for switching on the monitoring of a position sensor when a measurement signal of the position sensor for detecting the travel increments which is to be switched on has settled within a predetermined tolerance band, and therefore incorrect measurements as the conveying element enters and exits the measurement region of a position sensor are avoided.

In a particularly preferred embodiment, the switching device can additionally have a presence sensor which is suitable for activating the monitoring of a position sensor when a predetermined portion of the grid is in its measurement region. In this way, the position sensors can be switched on and switched off in a situation-related manner, this considerably reducing the energy consumption in the case of relatively large running rails with a corresponding number of position sensors.

This can preferably be performed on the conveying element by a measurement transmitter in addition to the grid, with the presence sensor being suitable for activating the monitoring of the position sensor based on the presence of the measurement transmitter in its measurement region.

The position sensors can be at a constant sensor distance from one another on the running rail segments, with the external position sensors of each running rail being at a distance of half the sensor distance from the edge of the running rail elements. This ensures that the sensor distance remains constant after the complete running rail is assembled.

### BRIEF DESCRIPTION OF THE DRAWINGS

Preferred exemplary embodiments of the invention will be described in detail below with reference to the accompanying drawing, in which:

FIG. 1 shows a schematic illustration of a transportation apparatus according to the invention;

FIG. 2 shows a schematic illustration of a running rail segment for a running rail of the transportation apparatus from FIG. 1 according to a first exemplary embodiment;

FIG. 3 shows a schematic illustration of a conveying element for use on a running rail which is constructed from running rail segments according to FIG. 2;

FIG. 4 shows a schematic illustration of a running rail segment for a running rail of the transportation apparatus from FIG. 1 according to a second exemplary embodiment;

FIG. 5 shows a schematic illustration of a conveying element for use on a running rail which is constructed from running rail segments according to FIG. 4; and

FIG. 6 shows a schematic illustration of a conveying element for use on the running rail of the transportation apparatus from FIG. 1 according to a third exemplary embodiment.

### DETAILED DESCRIPTION

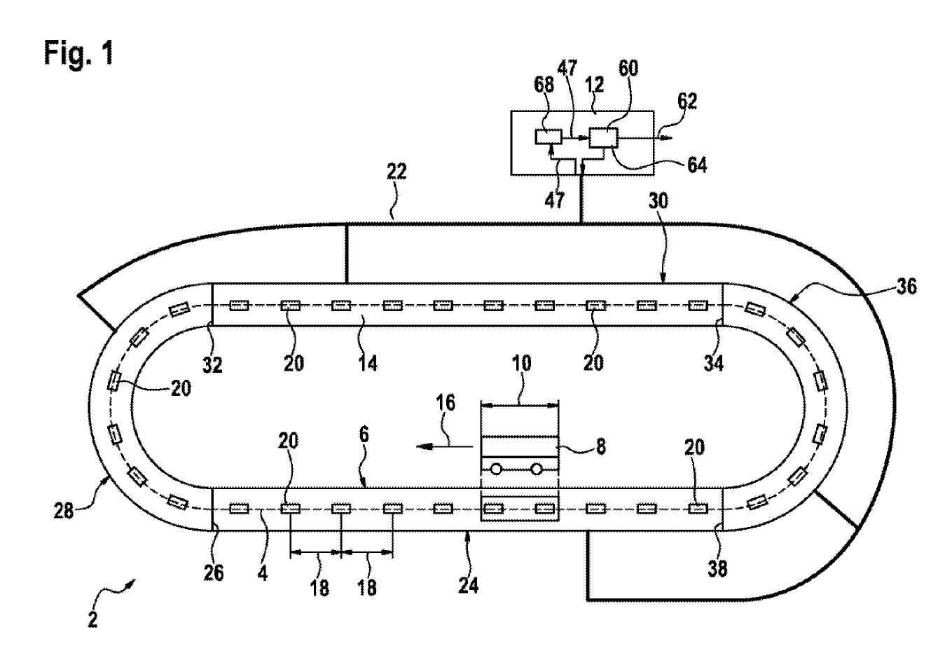

A transportation apparatus 2 having an incremental travel measurement system according to a first exemplary embodiment will be described below with reference to FIGS. 1 to 3.

FIG. 1 schematically shows the construction of the transportation apparatus 2 with an individual sensor track 4. The transportation apparatus 2 comprises a running rail 6, a conveying element 8 with a predetermined conveying element length 10 and a measurement device 12. The transportation apparatus 2 transports products between various points on the running rail 6 using the conveying element 8.

The running rail 6 is closed all the way around and has a running path 14 which defines a running distance for the conveying element 8. The sensor track 4 is embedded in the running track 14, and therefore the conveying element 8 can move back and forth in a specific running direction 16 on the running rail 6 and over the sensor track 4. By way of example, the sensor track 4 extends over the center line of the base of the running path 14 of the running rail 6. However, it can also extend over any imaginable path of the running rail 6, for example at the side walls.

A large number of magnetic field sensors 20 for detecting the position of the conveying element 8 on the running rail 6 are arranged on the sensor track 4 at a constant distance 18. These magnetic field sensors 20 can be designed, for example, as Hall sensors or MR sensors. In order to clearly illustrate the magnetic field sensors 20 and the distances 18 between said magnetic field sensors, only some of the magnetic field sensors 20 and the distances 18 between said magnetic field sensors are provided with a reference symbol in FIG. 1. The magnetic field sensor distance 18 on the sensor track 4 is smaller than the conveying element length 10.

Each of the magnetic field sensors 20 communicates with the measurement device 12 via a data bus 22 and sends its detected measurement data to said measurement device via a measurement signal 47.

The running rail 6 of the transportation apparatus 2 of the present embodiment is composed in a modular manner of a plurality of running rail segments. A first linear running rail segment 24 is connected to a first base rail element 28 by means of a first plug connection 26. A second linear running rail segment 30 is connected to the first base rail element 28 by means of a second plug connection 32 and to a second base rail element 36 by means of a third plug connection 34. Finally, the second base rail segment 36 is connected to the first linear running rail segment 24 by means of a fourth plug connection, and therefore the shape of the running rail shown in FIG. 1 is finally achieved. The plug connections 26, 32, 34, 38 can have standardized interfaces and abutment edges, and therefore the individual running rail segments 24, 28, 30, 36 can be lined up with one another in a seamless manner.

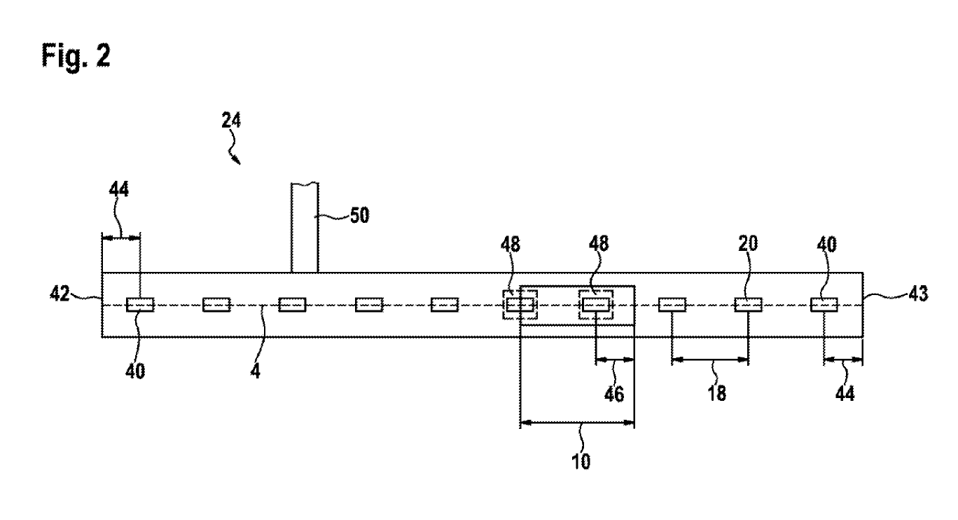

FIG. 2 illustrates, by way of example, the first linear running rail segment 24 of the present embodiment of the transportation apparatus 2. In said figure, elements which have already been described in FIG. 1 are provided with the same reference symbols and will not be described again. The following explanations concerning the first linear running rail segment 24 relate to all running rail segments 24, 28, 30, 36 which form the running rail 6.

The linear running rail segment 24 has two external magnetic field sensors 40 which are in each case arranged on the left-hand edge 42 and right-hand edge 43 of the linear running rail segment 24. The arrangement of the magnetic field sensors 20 between the external magnetic field sensors 40 over the sensor track 4 is not changed in comparison to FIG. 1. The external distance 44 of the external magnetic field sensors 40 to the edges 42 is half the above-described magnetic field sensor distances 18. In this way, the constant magnetic field sensor distance 18 over the entire sensor track 4 is achieved after the individual running rail segments 24, 28, 30, 36 are assembled. As a result of the magnetic field sensor distance 18 being smaller than the conveying element length 10, the conveying element 8 at least partially covers the measurement regions 48 of two magnetic field sensors 20 at the same time as the magnetic field sensors 20 move over into transition regions 46. Only one example of these transition regions 46 for a single magnetic field sensor 20 is illustrated in FIG. 2. However, a transition region periodically occurs in front of and behind each of the magnetic field sensors 20 which is arranged on the sensor track 4. That is to say, in each case two magnetic field sensors 20 provide a valid measurement signal 47 in the transition regions 46. In order to connect the magnetic field sensors 20 to the data bus 22 and therefore to the measurement device 12, the first linear running rail segment 24 has an interface 50.

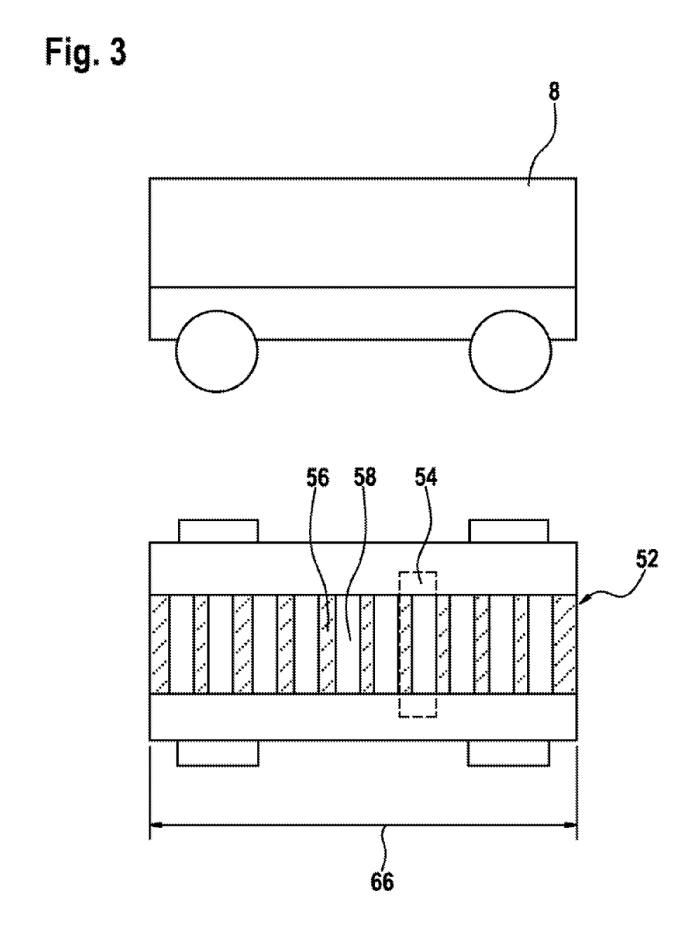

The conveying element 8 of the present embodiment illustrated in FIG. 1 will be described in greater detail in the text which follows with reference to FIG. 3 which shows the conveying element 8 from the lower face. Elements which have already been described in FIGS. 1 and 2 are provided with the same reference symbols in FIG. 3 and will not be explained again.

The conveying element 8 has, on its lower face, a magnetic strip 52 in the form of a grid which is constructed from a large number of magnets 54 which are lined up next to one another with opposing polarity, with one of the magnets 54 being bordered with a dashed line by way of example in FIG. 3. As an alternative, the magnetic strip 52 can also be arranged on the side of the conveying element 8. The other magnets 54 are not bordered or provided with a reference symbol for the sake of clarity. On account of the magnets 54 being lined up with one another with opposing polarity, a south pole 56 of one of the magnets 54 always bears against the north pole 58 of another of the magnets 54, with only one south pole 56 and one north pole 58 being provided with a reference symbol in FIG. 2 for the sake of clarity of the illustration. In this case, the length 66 of the magnetic strip 52 corresponds to the conveying element length 10.

If the magnetic strip 52 of the conveying element 8 enters the measurement region 48 of one of the magnetic field sensors 20, said magnetic field sensor 20 detects the entry and sends a measurement signal 47 to an evaluation circuit 60 in the measurement device 12. Said measurement device references the position 62 of the conveying element 8 in relation to a specific value on the basis of the position of this magnetic field sensor 20. As the conveying element 8 moves further over the magnetic field sensor 20, said magnetic field sensor detects a periodically alternating magnetic field on account of the north and south poles 56, 58 alternately passing the magnetic field sensor 20. The corresponding magnetic field sensor 20 converts each period of the alternating field into a counting pulse and sends said counting pulse, in the measurement signal 47 via the data bus 22, to the measurement device 12 which counts the generated counting pulses in the evaluation circuit 60 and as a result updates the previously referenced position 62 of the conveying element 8 on the running rail 6 by virtue of corresponding incrementation. Therefore, the magnetic field sensors 20 form an incremental sensor/travel pick-up and the magnetic strip 52 forms an incremental track for an incremental travel measurement system. Therefore, the measurement device 12 always outputs the exact position 62 of the conveying element 8. As an alternative or in addition, the position 62 of the conveying element 8 can also be referenced when the conveying element 8 moves out of a measurement region 48 of a magnetic field sensor 20.

In the transition region 46 between two magnetic field sensors 20, the measurement device activates an individual magnetic field sensor 20 by means of the evaluation circuit 60, for example with a computer-assisted comparator circuit which activates and deactivates the individual magnetic field sensors 20, and deactivates the other magnetic field sensors 20, by means of an activation signal 64.

In order to avoid jumps in the signal which outputs the position 62 of the conveying element 8, the evaluation circuit 60 can also weight the activation signal 64 in order to implement a fluid transition by means of a smooth changeover of the magnetic field sensors 20, so that each magnetic field sensor 20 is smoothly deactivated from 100% to 0% and is smoothly activated from 0% to 100%.

In the present embodiment, the changeover of the magnetic field sensors 20 which output the valid measurement signal 47 and the evaluation of the counting pulses of the valid measurement signal 47 are integrated in the evaluation circuit 60, by way of example in the measurement device 12. However, as an alternative, it can also be integrated in the magnetic field sensors 20 themselves, and therefore the direct positions 62 of the individual conveying elements can be transferred to the measurement device 12 by means of the bus system 22. Distribution of the changeover logic system to the magnetic field sensors 20 and the evaluation of the counting pulses to the measurement device 12 is likewise possible.

The conductor tracks for connection of the supply voltage, shielding and measurement signal lines to the individual magnetic field sensors 20 can be printed onto the lower face of the running rail segments 24, 28, 30, 36 and be routed to the bus interface 50.

Several options are available for changing over from one magnetic field sensor 20 to the next at the correct time and/or in the correct position without faults. In the case of magnetic field sensors 20, this is necessary since a certain transient response occurs as the magnetic strip 52 moves into and out of a magnetic field sensor 20. Firstly, this transient response is natural since not all the measurement elements of the magnetic field sensor 20 are excited to perform measurement by the magnetic strip 52 any longer as the magnetic strip moves in/out and therefore the counting pulses which are calculated from the values of all the measurement elements of a magnetic field sensor 20 are not yet correctly output. Secondly, the magnetic field sensors 20 still exhibit amplitude control and other monitoring and processing functions which lead to an undefined signal output as the magnetic strip moves in/out.

One option for changing over between two magnetic field sensors 20 without faults involves generally determining the presence of the magnetic strip 52 in the measurement region 48 of a magnetic field sensor 20, and using a switching unit 68 to suppress the output of the measurement signal 47 to the evaluation circuit 60 until the measurement signal 47 has settled at a stable signal state. The presence determination process can be performed in the switching unit 68 solely based on whether a magnetic field sensor 20 actually outputs a measurement signal 47, with the state of the measurement single 47 still not being taken into consideration.

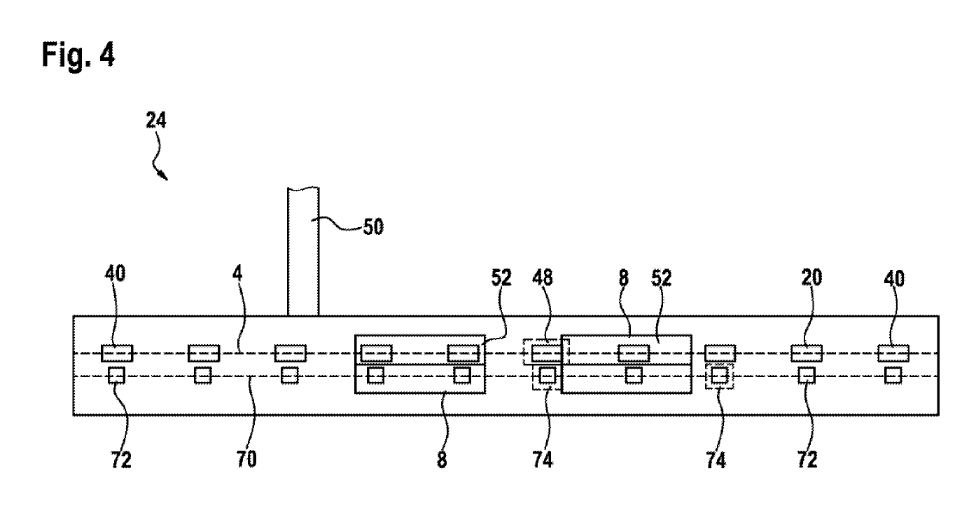

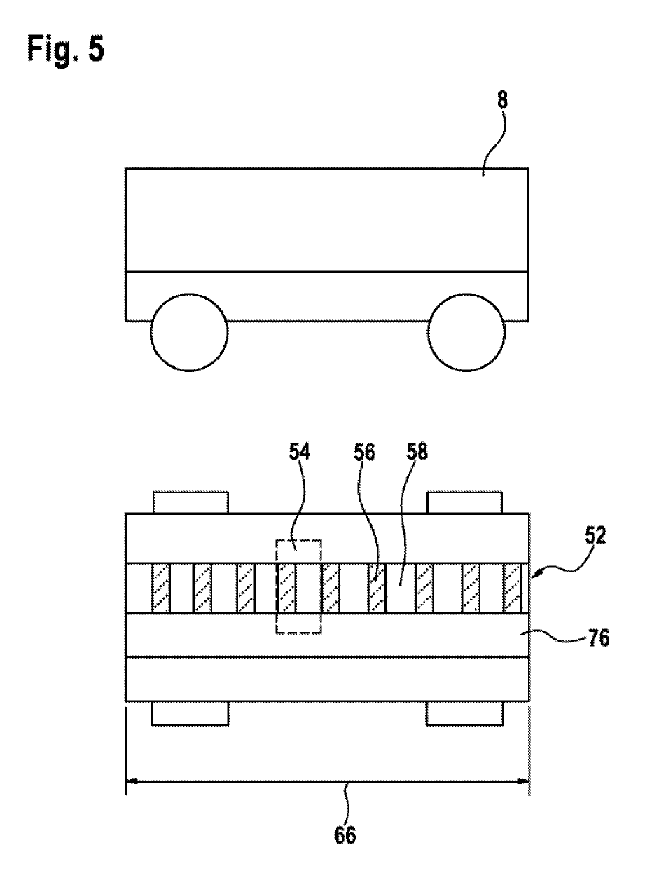

A second exemplary embodiment of the invention with which the fault-free changeover between two magnetic field sensors 20 is possible as an alternative will be explained in the text which follows with reference to FIGS. 4 and 5. In FIGS. 4 and 5, elements which correspond to elements in FIGS. 1 to 3 are provided with the same reference symbols and are not described again in the text which follows.

As shown in FIG. 4, a second sensor track 70 is arranged on the individual running rail segments 24, 28, 30, 36, of which only the first linear running rail element 24 is illustrated in FIG. 4, in the second exemplary embodiment, additional magnetic field sensors 72 being arranged on said second sensor track in the same position as the magnetic field sensors 20 on the first sensor track 4 in the running path 14. However, in contrast to the magnetic field sensors 20, the additional magnetic field sensors 72 have a reduced measurement region 74, and therefore the conveying element enters the measurement region 48 of the magnetic field sensors 20 earlier but leaves it later.

As shown in FIG. 5, a further magnetic strip is arranged parallel to the magnetic strip 52 on the lower face of the conveying element 8 in the second exemplary embodiment, said further magnetic strip having, however, only one permanent pole 76.

This permanent pole 76 excites the additional magnetic field sensors 72 on the second sensor track 70 when the magnetic strip 52 has entered the measurement region 48 of a corresponding magnetic field sensor 20 to a sufficient extent. The measurement signal of an additional magnetic field sensor 72 can therefore be used by the switching unit 68 in the measurement device 12 to switch on/off or activate/deactivate a magnetic field sensor 20 which is arranged in the same position.

As an alternative, the measurement region 48 of the magnetic field sensors 20 and the measurement region 74 of the additional magnetic field sensors 72 can be designed to be of the same size, with the length of the permanent pole 76 on the conveying element 8 being somewhat shorter than the length of the magnetic strip 52.

In both cases, the difference in size between the measurement regions of the magnetic field sensors 20, 72 or the permanent pole 76 and the magnetic strip 52 has to be at least as large as twice the movement distance of the conveying element 8 which is required for the transient response of the measurement signal of the magnetic field sensors 20.

The suppression of the measurement signal 47 from the magnetic field sensors 20 during its transient response can alternatively also be performed directly by the individual magnetic field sensors 20, 72 themselves.

The advantage of the additional system comprising the permanent pole 76 and the additional magnetic field sensor 72 is that this provides presence identification for each magnetic field sensor 20 at the same time, it being possible to use this presence identification to clearly draw a conclusion as to whether there is currently a conveying element 8 in the active region of the magnetic field sensor 20. Since the magnetic field sensor 20 supplies a measurement signal 47 only when the conveying element 8, and therefore the magnetic strip 52, moves, this is particularly advantageous in the case of the reference run since a movement of the conveying element 8 has to be carried out during controlled operation for which it is necessary to have prior knowledge of how the drive has to be actuated, this being dependent on the current positions of the conveying element 8.

In addition, the absence of a conveying element 8 and therefore of the magnetic strip 52 over a magnetic field sensor 20 in some types of sensor, for example in the case of MR sensors, leads to undesired side effects, such as undesired oscillation of the measurement signal 47, it likewise being possible for this to be suppressed by the abovementioned presence identification in combination with a suitable logic circuit.

A further option, which is not shown in FIGS. 4 and 5, for fault-free changeover between two magnetic field sensors 20 involves evaluating an index signal of the magnetic field sensors 20.

This additional index signal is output by the magnetic field sensors in order to indicate whether there is a magnet in the measurement region of said magnetic field sensors. This index signal can be used in the same way for temporarily suppressing the output of the measurement signal 47 to the evaluation circuit 60.

In this case, the index signal of a magnetic field sensor 20 is at a constant value if there is no magnetic strip 52 over the magnetic field sensor 20. As soon as the magnetic strip 52 moves onto the magnetic field sensor 20, said index signal changes state. The measurement signal 47 from this magnetic field sensor 20 has not yet fully settled at this time, and therefore the measurement signal 47 of this magnetic field sensor 20 is not yet valid and therefore cannot be used yet.

On account of the changing state of the index signal of the magnetic field sensor 20, the current and valid value of the magnetic field sensor 20 which last output a valid measurement signal 47 to the evaluation circuit 60 can be stored by flank evaluation. A certain number of travel increments 56, 58 can then be counted further starting from this stored value. This number of travel increments 56, 58 is then at least as large as the region which is required for the transient response of the measurement signal 47 of the current magnetic field sensor 20.

If this number of travel increments 56, 58 is run through, the measurement signal 47 from the last magnetic field sensor 20 can be reliably changed over to the measurement signal 47 of the current magnetic field sensor 20.

In this case too, the changeover can be made on the sensor side or by the switching unit 68 in the measurement device 12.

Since the measurement system of the illustrated conveying apparatus 2 is an incremental measurement system, a reference run has to be carried out after each interruption in the travel measurement system.

If the running rail 6 is of substantially circular construction, with few straight running rail segments 24, 30, a modified construction of the magnetic strip 52 beneath the conveying element 8 can increase the measurement accuracy.

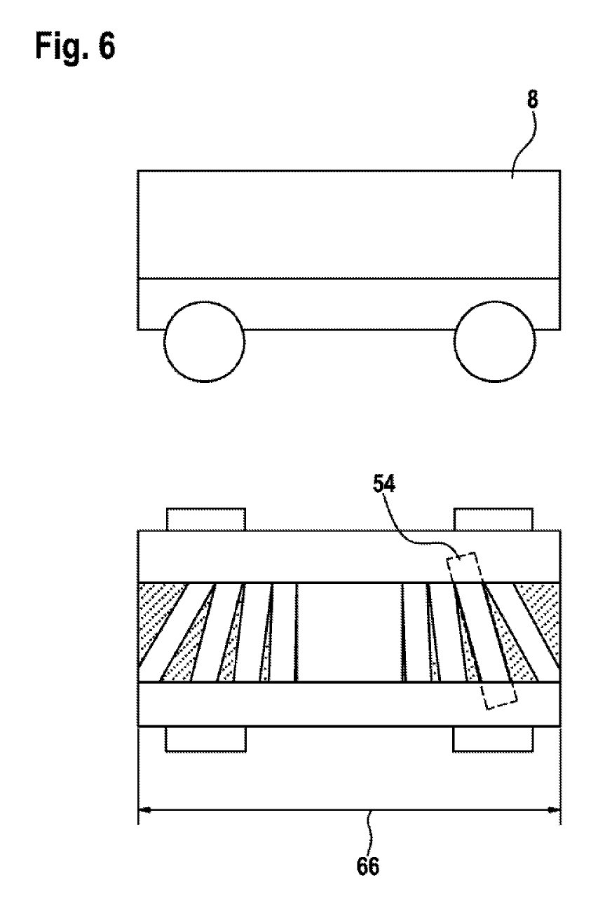

A construction of this kind is illustrated as a third exemplary embodiment in FIG. 6.

In this exemplary embodiment, identical reference symbols are used for identical elements to those of the above-described exemplary embodiments. As shown in FIG. 6, the magnets 54 are arranged in the form of a fan in the present example and are therefore guided over the magnetic field sensors 20 along the sensor track 4 in the event of a curved run through an arc element 28, 36, as a result of which the magnetic field which is output by the magnetic strip 52 likewise has a curved profile and is better detected by the magnetic field sensors 20 in the arc elements 28, 36, and therefore more reliable measurement results are possible.

In all the above-described embodiments, no additional sensors are required as reference marks since the magnetic field sensors 20 on the sensor track 4 can be used for this purpose because they can be assigned to unambiguous mechanical positions. Therefore, as soon as a magnetic field sensor 20 detects the magnetic strip 52 of a conveying element 8 on the sensor path 4, an unambiguous mechanical position on the running path 14 can be assigned to the conveying element 8, and therefore be used as a reference mark. In addition, the reference run is only as long as the distance 18 between two magnetic field sensors 20, and therefore the conveying element 8 does not have to move over the entire projected path profile of the transportation apparatus 2 for referencing purposes.

The described embodiments propose an incremental travel measurement system for a transportation apparatus, in which system the incremental sensors or travel pick-ups are arranged in a stationary manner in the form of a magnetic field sensor and the incremental track moves in the form of a magnetic strip, and therefore a new reference mark is present with entry of the incremental track into the measurement region of a new incremental sensor and independent reference marks can be dispensed with completely.

1. A transportation apparatus for conveying a product, the transportation apparatus comprising:
a movable conveying element (8), which is provided for conveying the product, having a grid (52) which extends over a predetermined grid length (66) in the movement direction (16) of the conveying element (8) and has a plurality of travel increments (56, 58);
a running path (14) which defines a running distance for the conveying element (8); a plurality of position sensors (20) which are arranged along the running path (14), and the distances (18) between said plurality of position sensors are smaller than the grid length (66), and
a measurement device (12) which is designed to determine a current position of the conveying element (8) on the running path (14), with the measurement device (12),
when the grid at least one of enters and exits a measurement region (48) of a position sensor (20), defining the current position with respect to a reference position, which is derived from the position of the corresponding position sensor (20), of the conveying element (8) on the running path (14),
monitoring at least one of the position sensors (20), the conveying element (8) being located in the measurement region (48) of said at least one position sensor, and
incrementing or decrementing the current position when a travel increment (56, 58) passes a monitored position sensor (20).

2. The transportation apparatus as claimed in claim 1, further comprising a stationary running rail (6) which runs along the running path (14), with the position sensors (20) being arranged in the running rail (6).

3. The transportation apparatus as claimed in claim 1, with the grid (52) being a magnetic strip, the travel increments (56, 58) of said magnetic strip being lined up next to one another with alternating polarity, and the position sensors (20) being magnetic field sensors.

4. The transportation apparatus as claimed in claim 3, with the travel increments (56, 58) which are lined up next to one another with alternating polarity diverging from one another in the form of a fan as seen from one side of the grid (52).

5. The transportation apparatus as claimed in claim 1, with the grid length (66) corresponding to a length (10) of the conveying element (8) in the movement direction (16) of the conveying element (8).

6. The transportation apparatus as claimed in claim 2, with the running rail (6) being composed of at least two running rail segments (24, 28, 30, 36).

7. The transportation apparatus as claimed in claim 1, with the measurement device (12) comprising an evaluation circuit (60) which, in a transition region (46) of the conveying element (8) between two position sensors (20), is suitable for switching on the monitoring of a position sensor (18) when the grid (52) enters a measurement region (48), and switching off said monitoring when the grid (52) exits the measurement region (48).

8. The transportation apparatus as claimed in claim 7, with the measurement device (12) in the transition region (46) being designed to weight the position sensors (20).

9. The transportation apparatus as claimed in claim 1, with the measurement device (12) having a switching device (68) which is suitable for switching on the monitoring of a position sensor (20) when a measurement signal (47) of the position sensor (20) for detecting the travel increments (56, 58), which position sensor is to be switched on, has settled within a predetermined tolerance band.

10. The transportation apparatus as claimed in claim 9, with the switching device (68) having a presence sensor (72) which is suitable for activating the monitoring of a position sensor (20) when a predetermined portion of the grid (52) is in a measurement region (48).

11. The transportation apparatus as claimed in claim 10, with the conveying element (4) having a measurement transmitter (76) in addition to the grid (52), and the presence sensor (72) is suitable for activating the monitoring of the position sensor (20) based on the presence of the measurement transmitter (76) in the measurement region (48).

12. The transportation apparatus as claimed in claim 2 wherein the running rail (6) is endless.

13. The transportation apparatus as claimed in claim 2, with the grid (52) being a magnetic strip, the travel increments (56, 58) of said magnetic strip being lined up next to one another with alternating polarity, and the position sensors (20) being magnetic field sensors.

14. The transportation apparatus as claimed in claim 13, with the travel increments (56, 58) which are lined up next to one another with alternating polarity diverging from one another in the form of a fan as seen from one side of the grid (52).
